(19) United States
(12) Patent Application Publication
(10) Pub. No.: US 2003/0027975 A1
(43) Pub. Date: Feb. 6, 2003

(54) Method for preparing saturated polyester with excellent mechanical properties

(75) Inventor: Deog Jae Jo, Kyongsangbuk-Do (KR)

Correspondence Address: John S. Egbert, Harrison & Egbert, 412 Main Street, 7th Floor, Houston, TX, 77002, US

(73) Assignee: Saehan Industries Incorporation

(21) Appl. No.: 09/917,184

(22) Filed: Jul. 30, 2001

(51) Int. Cl. C08G 63/02; C08L 1/00; C08J 3/00; C08K 5/00

(52) U.S. Cl. 528/272; 528/275; 528/281; 528/283; 528/286; 524/174; 524/175; 524/176; 524/401; 524/409; 524/413; 524/414; 524/432; 524/433; 524/436

(57) ABSTRACT

Disclosed is a method for preparing saturated polyester used in various molded products, such as films, synthetic fibers, vessels and housings. In particular, the method improves mechanical properties, including tensile strength or impact resistance, of saturated polyester. In DMT method or TPA method, the saturated polyester is synthesized through transesterification or esterification and polycondensation, in which metal compounds, such as metal acetate compounds, metal hydroxides, and metal oxides, are added in the larger amounts upon synthesis, and thus crystalline internal grains are formed, thereby improving the mechanical properties. As such, the metal compound can be used alone or in combination with a phosphorous-based compound.

### BACKGROUND OF THE INVENTION

1. Field of the Invention

The present invention relates to a method for preparing saturated polyester widely used in films, synthetic fibers and various molded products. In particular, the present invention relates to a method for improving mechanical properties of the polyester, by forming internal grains within polymer chains of polyester.

2. Description of the Prior Art

In general, saturated polyesters, which are known to be thermoplastic straight chain polymers having ester bonds, such as polyethylene terephthalate (PET), polybutylene terephthalate (PBT) and so on, have excellent dimensional stability, weatherability and desurfacing ability, and transparent and brilliant appearance, so that they have been widely used in molded products, including synthetic fibers, films, vessels, or housings.

However, such saturated polyesters suffer from lower impact resistance and tensile strength because of high melting points and crystallinity, comparing with other engineering plastics.

Commonly, as the method for improving the mechanical properties of synthetic resin, there is a method for kneading a filler or a reinforcing material, which is responsible for improving the mechanical properties upon melting extrusion or injection of synthesized basic resin. But this method is disadvantageous in that the filler or the reinforcing material is more expensive than basic resin, and thus preparation costs including various processing costs become higher.

Meanwhile, upon preparation of saturated polyesters, it is known that a metal compound is used as a catalyst during a synthesis reaction, or a metal compound or metal grains are used at a melting extrusion step upon synthesis of resin or after preparation of resin, so as to improve flame resistance and texture of polyester fibers.

In this regard, U.S. Pat. Nos. 4,307,152 and 4,371,485 refer to techniques for improving flame resistance and water retentivity of polyester fibers by adding a metal compound to polyester resin and spinning it. In addition, U.S. Pat. No. 4,545,949 discloses a technique for improving a spinning operation, along with reaction promotion, by using a metal compound as a transesterification catalyst.

In the conventional techniques as in the above, the metal compound is used in the small amount as a catalyst for simply promoting the synthesis reaction of polyester. However, when larger amounts of metal compound are used, saturated polyester contains the grains of metal compound (about 1-10 μm) as external grains, so that the metal compound cannot improve the mechanical properties of saturated polyester or rather decreases its properties.

### SUMMARY OF THE INVENTION

Therefore, it is an object of the present invention to overcome the above problems encountered in the prior arts and to provide a novel method for improving mechanical properties of saturated polyester, by adding a metal compound with ionic groups upon synthesis of saturated polyester resin, dispersing or reacting the metal ion in or with the polymer chain of polyester, and producing crystalline internal grains.

### DETAILED DESCRIPTION OF THE INVENTION

A method for preparing saturated polyester of the present invention is characterized in that a metal compound is used in an amount of 1-10 wt % on a basis of metal content when the saturated polyester is prepared through transesterification (or esterification) and polycondensation.

In the present invention, the saturated polyester is prepared by using an aromatic dicarbonic acid or an ester-forming derivative and ethylene glycol as main starting materials, and may further comprise another third component. The aromatic dicarbonic acid can be selected from the group consisting of isophthalic acid, terephthalic acid, 2,6-naphthalene dicarbonic acid, phthalic acid, adipic acid, sebacic acid, or mixtures thereof. As the glycol component, use can be made of ethlyene glycol. In addition, propylene glycol, butanediol, 1,4-cyclohexandimethanol, neopentylglycol and the like may be used in the small amounts.

As necessary, the saturated polyester synthesized in the present invention may further comprise additives, such as thermal stabilizers, antiblocking agents, antioxidants, antistatic agents, and ultraviolet absorption agents.

Upon synthesis of the saturated polyester using the above starting materials, the metal compound can be added thereto. Such metal compound, which can be present as metal ion in the reaction, is exemplified by metal acetate compounds, such as lithium acetate, sodium acetate, potassium acetate, calcium acetate, manganese acetate, magnesium acetate, zinc acetate, and antimony acetate; metal hydroxides, such as lithium hydroxide, sodium hydroxide, potassium hydroxide, calcium hydroxide, manganese hydroxide, zinc hydroxide, magnesium hydroxide; metal oxides, such as antimony oxide, germanium oxide, titanium oxide. The metal compound can be used alone or in mixtures thereof.

The metal compound is preferably used in the amount of 1-10 wt %, based upon the metal content, and more preferably, in the amount of 1.5-3.0 wt %. If the amount is less than 1 wt %, internal grains are formed but mechanical properties are not improved. On the other hand, if the amount exceeds 10 wt %, the processability becomes poor and normal reaction is not conducted well, also stability of the properties is decreased.

In addition, when the metal compound is added, phosphorous-based compounds, including phosphoric acid, TMP (tri methyl phosphate), TEP (tri ethyl phosphate), and TPP (tri phenyl phosphate), may be added together. In such a condition, phosphorous-based compounds are responsible for improving color of resin and the mechanical properties by a formation of salts with metal ion in the resin. Such phosphorous-based compound is regulated in its amount to be added, considering a stoichiometric ratio with the metal ion, and thus is preferably added in the amount of 0.05-5.0 wt %, on the basis of phosphorous content.

As described above, when the metal compound alone or a mixture of metal compound and phosphorous-based compound is added upon synthesis of polyester, the addition process and time are not limited in the present invention. However, in the case of DMT; (dimethylterephthalate) method, simultaneous addition of lager quantities results in flooding caused by rapid reaction, thus blocking the whole reaction system. Therefore, slow addition of the above compounds is preferable. Additionally, after the esterification is progressed 70% or more, the compounds are preferably added. If that happens, stability against flooding becomes high.

TPA (terephthalic acid) method is not limited in the addition process and time, because danger of flooding is low. But, when esterification is progressed 90% or more, the compounds are preferably added. Fast addition of metal compound dissolved in EG results in drastic decrease of the reaction temperature, so causing problems of reduced reaction rate. Hence, it is preferred that the compounds are slowly added (over 20 minutes or longer).

The metal compound and the phosphorous-based compound introduced upon transesterification or polymerization produce grains in a BHT (bis-p-hydroxy ethylene terephthalate)-Me form or a BHT-Me-P form. The produced grains are present within the BHT in a form (internal grain) formed by the reaction of polymer chain and metal ions of angstrom or nano scale. Such BHT comprises strong crystalline grains. The internal grains have different sizes depending on a polymerization degree of BHT. High polymerization degree of BHT leads to an increase of the total amount and the size of the produced internal grains.

Meanwhile, the metal compound may be added in a solid form, but the metal compound sufficiently dissolved in the monomers, such as EG, is favorably used, thereby obtaining easy metal ionization and uniform size of the internal grains.

Having generally described this invention, a further understanding can be obtained by reference to certain specific examples which are provided herein for purposes of illustration only and are not intended to be limiting unless otherwise specified.

### EXAMPLE 1

100 parts by weight of terephthalic acid (TPA) and 45 parts by weight of ethylene glycol (EG) were introduced into a reactor, and heated with stirring, and thus the temperature of the reaction was increased from 190° C. to 230° C. Subsequently, transesterification was carried out for 4 hours, to prepare BHT, which was then added with 135 parts by weight of melted EG with a calcium acetate content of 8.0 wt % while maintaining the reactor temperature at 220° C. While the reactor was heated with stirring, the temperature was increased from 220° C. to 240° C., to which 143 parts by weight of a slurry having a molar ratio of EG to TPA of 1.15 was introduced over 2 hours and further reacted with maintaining the temperature at 240° C. Thereafter, 0.03 parts by weight of antimony trioxide was added thereto and the reaction was depressurized to 1.0 torr for 40 minutes. Polycondensation was performed for 3 hours at temperature increased from 240° C. to 285° C. over 50 minutes, to yield polyester (I).

### EXAMPLE 2

The same procedure as set forth in Example 1 was carried out, except that 135 parts by weight of melted EG with a lithium acetate content of 8.0 wt %, instead of calcium acetate, was used, to yield polyester (II).

### EXAMPLE 3

100 parts by weight of TPA and 45 parts by weight of EG were introduced into a reactor, and heated with stirring, and thus the temperature of the reaction was increased from 190° C. to 230° C. Thereafter, transesterification was carried out for 4 hours, to prepare BHT, which was then added with 22.4 parts by weight of a mixture of phosphoric acid and EG, having 3.0 wt % of phosphoric acid, and then 135 parts by weight of melted EG with a calcium acetate content of 8.0 wt % while maintaining the reactor temperature at 220° C. While the reactor was heated with stirring, the temperature was increased from 220° C. to 240° C., to which 143 parts by weight of a slurry having a molar ratio of EG to TPA of 1.15 was introduced over 2 hours and further reacted while maintaining the temperature at 240° C. for 1.5 hours. Thereafter, 0.03 parts by weight of antimony trioxide was added thereto and the reaction was depressurized to 1.0 torr for 40 minutes. Polycondensation was performed for 3 hours at temperature increased from 240° C. to 285° C. over 50 minutes, to yield polyester (III).

### EXAMPLE 4

The same procedure as set forth in Example 3 was carried out, except that a mixture of phosphoric acid and EG, having 3.0 wt % of phosphoric acid, was used in the amount of 6.9 parts by weight, and 135 parts by weight of melted EG with a lithium acetate content of 8.0 wt %, instead of calcium acetate, was used, to obtain polyester (IV).

### COMPARATIVE EXAMPLE 1

100 parts by weight of terephthalic acid and 45 parts by weight of ethylene glycol were introduced into the reactor, and heated with stirring, and the temperature of the reaction was increased from 190° C. to 230° C., to perform esterification for 4 hours. 0.04 parts by weight of antimony trioxide and then 0.015 parts by weight of phosphoric acid were mixed with 1 part by weight of ethylene glycol. The reaction was depressurized for 4 hours at increased temperature range of 230-285° C., and then polycondensation was carried out, to yield polyester (V).

Table 1, below, shows physical properties of the polymers obtained in the above examples and comparative example.

TABLE 1

| Items | | Unit | Ex. 1 | Ex. 2 | Ex. 3 | Ex. 4 | C. Ex. 1 | Test standard |
|---|---|---|---|---|---|---|---|---|
| I.V. | | — | 0.70 | 0.70 | 0.70 | 0.70 | 0.70 | ASTM-D-4603 |
| Color | L | — | 84 | 75 | 78 | 72 | 55 | JIS-Z-8730 |
| | value | | | | | | | |
| | B | — | 3.0 | 2.8 | 1.5 | 1.3 | 0.0 | |
| | value | | | | | | | |

| | | | | | | | |
|---|---|---|---|---|---|---|---|
| D.S.C (Tm) | ° C. | 251 | 251 | 250 | 250 | 252 | ASTM-D-3418 |
| —COOH | eq/ton | 25 | 24 | 20 | 19 | 30 | N/25NaOH |
| | | | | | | | Titration |
| HAZE | % | 85 | 76 | 56 | 48 | 0.7 | ASTM-D-1003 |
| Moisture | Wt % | 0.2 | 0.2 | 0.2 | 0.2 | 0.2 | ASTM-D-1364 |
| content | | | | | | | |

Each of polyesters obtained in the above examples 1-4 and the comparative example 1 was melted at 285° C. in an injection molding machine. Test pieces were prepared at the molding temperature of 80° C., and allowed to stand at 23° C. and a relative humidity of 50% for 40 hours. Then, tensile strength and impact strength of the pieces were measured and are shown in Table 2, below. As such, the measuring method was as follows.

TABLE 2
Tensile strength (kgf/cm²): ASTM D638
Impact strength (kg cm/m): ASTM D256

| | Ex. 1 | Ex. 2 | Ex. 3 | Ex. 4 | C. Ex. 1 |
|---|---|---|---|---|---|
| Tensile strength | 1190 | 1070 | 1100 | 1060 | 1010 |
| Impact strength | 13 | 11 | 12 | 10 | 10 |

Accordingly, the saturated polyesters with crystalline internal grains in the polymer, prepared according to the present invention, have more excellent mechanical properties than those of conventional saturated polyesters. In addition, the present polyester is advantageous in light of lower preparation cost, compared with products prepared by use of expensive filler or reinforcing material.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for preparing saturated polyester with excellent mechanical properties, wherein a metal compound is added in the amount of 1-10 wt % on the basis of metal content upon transesterification or esterification and polycondensation, to yield saturated polyester.

2. A method for preparing saturated polyester with excellent mechanical properties, wherein a metal compound is added in the amount of 1-10 wt % on the basis of metal content and a phosphorous-based compound is added in the amount of 0.05-5.0 wt % on the basis of phosphorous content upon transesterification or esterification and polycondensation, to yield saturated polyester.

3. The method as set forth in claim 1 or 2, wherein the metal compound is selected from the group consisting of lithium acetate, sodium acetate, potassium acetate, calcium acetate, manganese acetate, magnesium acetate, zinc acetate, antimony acetate, lithium hydroxide, sodium hydroxide, potassium hydroxide, calcium hydroxide, manganese hydroxide, zinc hydroxide, magnesium hydroxide, antimony oxide, germanium oxide, titanium oxide, or mixtures thereof.

4. The method as set forth in claim 2, wherein the phosphorous-based compound is selected from the group consisting of phosphoric acid, tri methyl phosphate, tri ethyl phosphate, tri phenyl phosphate, or mixtures thereof.
